(19) United States
(12) Patent Application Publication
(10) Pub. No.: US 2021/0034505 A1
(43) Pub. Date: Feb. 4, 2021

(54) MODIFIED EXECUTABLES

(71) Applicant: HEWLETT PACKARD ENTERPRISE DEVELOPMENT LP, Houston, TX (US)

(72) Inventors: Shaun Wackerly, London, KY (US); Vali William Lean, Sacramento, CA (US)

(21) Appl. No.: 16/526,084

(22) Filed: Jul. 30, 2019

(51) Int. Cl. G06F 11/36; G06F 9/54; G06F 16/27

(52) U.S. Cl. CPC G06F 11/3688; G06F 16/27; G06F 9/54; G06F 11/3692

(57) ABSTRACT

Example implementations relate to testing an original executable. In an example, the original executable is received at a network device. A modified executable is generated by replacing calls in the original executable to production application programming interfaces (APIs) with calls to mock APIs. The modified executable is executed on the network device. Information associated with execution of the modified executable on the network device is recorded for post-execution analysis.

### BACKGROUND

Network devices may include routers, switches, hubs, and the like. Network devices may be useful for connecting computing systems, storage systems, other network devices, or other electronic devices. Network devices may be configurable.

### BRIEF DESCRIPTION OF THE DRAWINGS

Various examples will be described below with reference to the following figures.

FIG. 1 depicts an example network device that generates and executes a modified executable.

FIG. 2 depicts an example system with a machine readable medium that includes instructions to generate and execute a modified executable.

FIG. 3 depicts an example system with a machine readable medium that includes instructions associated with post-execution actions.

FIG. 4 depicts an example method that includes generating and executing a modified executable.

FIG. 5 depicts an example method that includes sending information to an executable management system.

### DETAILED DESCRIPTION

Some electronic devices, including some network devices (e.g., switches, routers, hubs, etc.), may allow users to automate certain operations and functionality through the use of executables that are executed on the electronic devices themselves. An executable may include a script or a pre-compiled application. On a network device, an executable may be useful for monitoring, for diagnostics, for automatically responding to network conditions or events, and for other purposes.

An executable may make calls to one or more application programming interfaces (APIs). An API may be an internal API that is directed to the internal operation of the device on which the executable is executing. An API may be external API (e.g., a REST API), such as an API of a system that is external to the device on which the executable is executing.

In some examples, an executable fora device may be created by a user of the device and also may be shared among the community of device users. However, a user may not have an efficient and effective means to safely test their executable before releasing it into a live deployment. Moreover, it may be possible that a shared executable may unintentionally or intentionally (e.g., maliciously) cause undesired configuration changes or even damage to a device or the device's environment. Although it may be possible for a user to set up a separate test environment to test an executable, such a test environment may be costly and time consuming.

Thus, it may be useful to provide for a user creating an executable or obtaining a third-party executable the ability to test whether the executable will operate correctly on a device itself without actually modifying or otherwise impacting the device and anything connected to the device. Examples described herein may relate to a method, a system, and a machine readable medium storing instructions that receives an original executable to be tested (either developed by the user or obtained from a third-party) and replaces production API calls in the original executable with mock API calls. The mock API calls can operate in a variety modes, including a mode to perform user dictated behaviors, a mode to perform production API behaviors unless a specified condition occurs, a mode to read/write to a shadow database, a mode to record that a call to a mock API was made, or other modes. The modified executable with mock API calls can be executed in a deployed device without impacting the deployed device or the deployment environment in which the device operates, by virtue of replacing production API calls that could otherwise affect the deployed device or environment. Information about the execution of the modified executable can be analyzed to determine the would-be performance and impact of running the original executable on the device. This information may be more detailed, more accurate, and more useful for testing performance of executables than any information that may be collected by an external network entity that periodically listens in on the device. Additionally, the information may be utilized to generate a trustworthiness score for the tested executable.

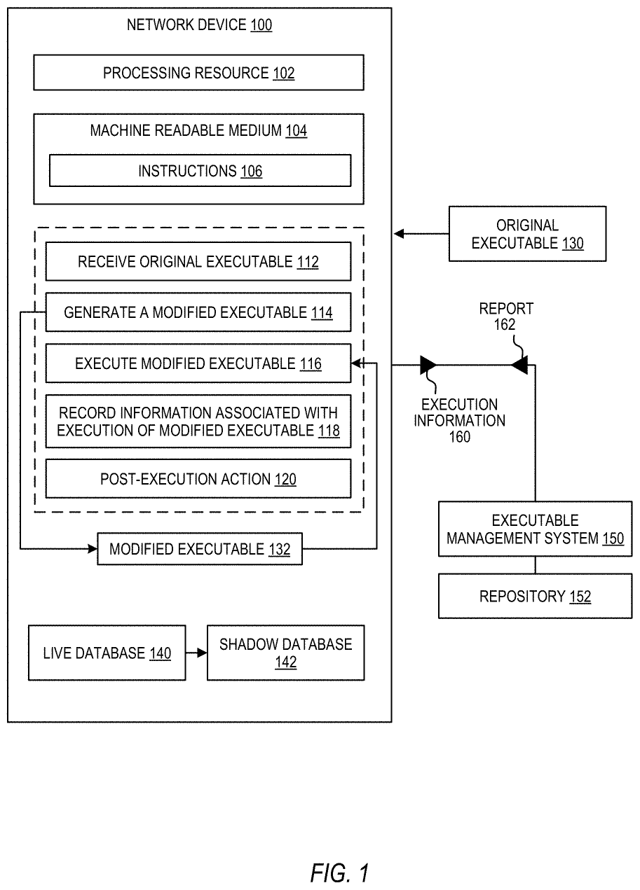

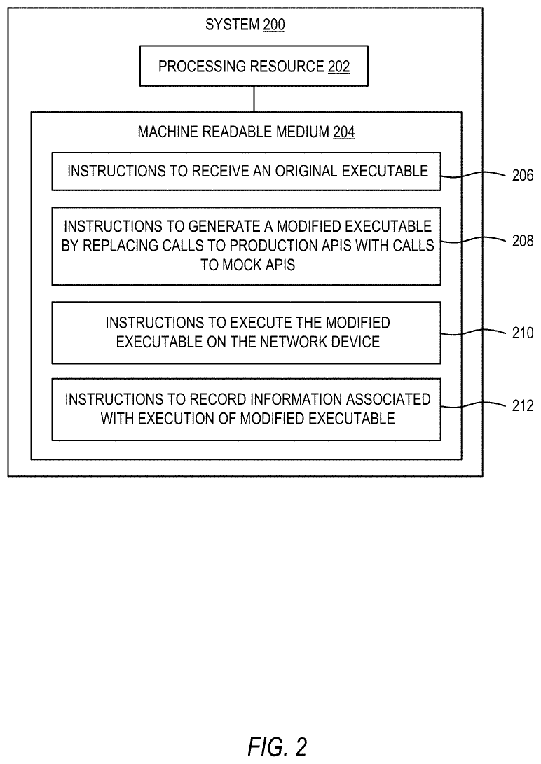

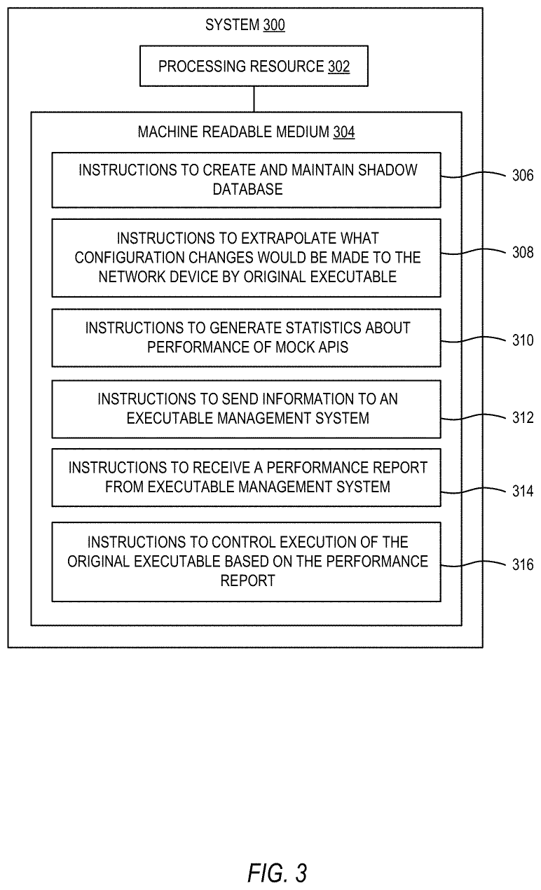

Referring now to the figures, FIG. 1 illustrates an example network device 100. The network device 100 may be a switch, a hub, a router, etc., and may provide any wired and/or wireless connectivity. The network device 100 includes a processing resource 102 and a machine readable medium 104. The processing resource 102 may include a microcontroller, a microprocessor, central processing unit core(s), an application-specific integrated circuit (ASIC), a field programmable gate array (FPGA), or the like. The machine readable medium 104 may be non-transitory (i.e., does not encompass transitory propagating signals) and may include random access memory (RAM), read-only memory (ROM), electrically erasable programmable read-only memory (EEPROM), flash memory, a hard disk drive, solid state disk, or the like. The machine readable medium 104 stores instructions 106 (i.e., programming or code). In some implementations, instructions 106 may include at least some of the instructions described below with reference to FIGS. 2 and 3.

The processing resource 102 may execute instructions 106 stored on the machine readable medium 104 to perform functions of the network device 100, which may include some or all of the functionality 112, 114, 116, 118, 120 (collectively, functionality 112-120) described herein. Additionally or alternatively, the processing resource 102 may include electronic circuitry for performing the functionality 112-120. In other words, the network device 100 may be understood to perform the functionality 112-120 via at least the processing resource 102. In some implementations, the functionality 112-120 and the associated instructions 106 may form part of or be related to an operating system of the network device 100, and more particularly, to an analytics engine of the operating system.

In some implementations, operation of the network device 100 may be based on a live database 140. For example, the network device 100 or an operating system of the network device 100 may utilize a database driven architecture. For example, the live database 140 may store configuration information and state information of the network device 100 and processes thereof.

The network device 100 may perform functionality 112 to receive an original executable 130 to be tested. For example, the original executable 130 may be loaded to the network device 100 by a user, may be pushed to the network device 100 from a repository (e.g., repository 152 described below), or otherwise delivered by any other electronic means. The original executable 130 may be a script (e.g., a Python script) or may be a pre-compiled executable (e.g., an executable Java Archive, or JAR, file). In some scenarios, the original executable 130 may be provided to the network device 100 for the purpose of testing the original executable 130.

In some cases, the original executable 130 may make calls to production APIs to receive input, such as data and events about the network device 100 or the associated network environment, and/or to perform some action on the network device 100 or on an external system. The production APIs are described as “production” in that the APIs are published, open, or otherwise knowable by developers. A production API may be an internal API that calls locally to the network device 100, such as an API to read from and/or write to a configuration, a status, or a statistic of the network device 100 itself. Examples of internal APIs may include an API to check on resource usage (e.g., CPU, memory, network, etc.), an API to make configuration changes (e.g., write a configuration to a database), or other types of APIs. In some cases, a production API may be an external API that calls to an external or remote system (i.e., a system external or remote to the network device 100), such as an API to send an email to a distribution.

The network device 100 may perform functionality 114 to generate a modified executable 132. In some instances, generating a modified executable may include replacing, in part or in whole, some or all calls to production APIs in the original executable 130 with calls to mock APIs. For example, for a script-type of original executable 130, functionality 114 may include stepping through a copy of the executable 130 and replacing identifiable production API calls with mock API calls or with redirects to alternate APIs to generate the modified executable 132. A pre-compiled original executable 130 may have dependencies that are annotated or that can be determined by analyzing the files embedded within the executable 130 (e.g., using a Java dependency analysis tool on JAR files). For a pre-compiled executable 130, functionality 114 may include analyzing the annotations or the embedded files to determine what dependency calls the executable 130 makes, and then replacing those calls with calls to mock APIs or redirects to alternate APIs. For example, replacing the calls of a pre-compiled executable 130 may include intercepting network communication related to the identified dependency calls and redirecting the calls to mock APIs.

In some implementations, for either script or pre-compiled executables, replacing an API call may include changing a “context” of the call to a context associated with mock API behavior. For example, context may be based on a session, username, process space, etc.

In some implementations, functionality 114 may be fully automated using defined API replacement logic for known APIs or may be user-guided. Functionality 114 may perform replacements on a per call basis (e.g., each call may possibly be replaced in a different manner), on a per API basis (e.g., replace a particular API in the same manner every time that API is called in the executable), on a global basis (e.g., all API calls are replaced in the same manner), or on other bases.

Before describing the mock APIs in more detail, a shadow database 142 that may be used by some mock API calls will first be described. In some implementations, the instructions 106 may include instructions that cause the processing resource 102 to create and maintain a shadow database 142. The shadow database 142 may be a copy of the live database 140. More particularly, the shadow database 142 may be synchronized one-way from the live database 140. In other words, the shadow database 142 may be an up-to-date copy of the live database 140. Any write calls to the live database 140, such as writes from network device 100 daemons or writes from network device 100 activity in a live deployment environment, may be replicated in to the shadow database 142. For example, writes to the live database 140 may be replicated by a small layer in the live database 140, and although the small layer may be aware of the replication, the daemon writing into the live database 140 would not be aware of the replication.

On the other hand, any write calls to the shadow database 142 by the modified executable 132 are only made to the shadow database 142 and would not be replicated to the live database 140. Use of the shadow database 142 may be limited to the modified executable 132, and vice versa, by associating the shadow database 142 with a context dedicated to mock execution and configuring the mock APIs to use that context. Normal operation of the network device 100 may not use or even have knowledge of the mock execution context, and thus would not be affected by the shadow database 142. By virtue of the foregoing, the modified executable 132 can use up-to-date information from the shadow database 142 as if using the live database 140, without affecting the actual live database 140 and concurrent operation of the network device 100. At the same time, in some implementations, the shadow database 142 could be modified, by a user for example, to control input to the modified executable 132.

A mock API call may include one or more of a variety of modes of behavior. In some implementations, multiple modes may be used in conjunction in a mock API call. For example, a mock API call may include a logging mode, that is, a mode to record read and/or write calls of mock APIs, to record that a call to the mock API was made, and/or to record that a call to an unmodified production API was made. Logged information may be useful for post-execution analysis.

In another example, a mock API may include a read-only mode. In a read-only mode, the mock API may be limited to reading from either the shadow database 142 or the live database 140. The read-only mode may be useful for replacing APIs that would otherwise write to the live database 140.

Another example of a mock API may include a mode to read from and/or write to the shadow database 142, instead of the live database 140. A shadow database read/write mode may be less limiting than a read-only mode, and also may be useful for capturing the output of the modified executable 132 in the shadow database 142 for later analysis.

In another example, a mock API mode may change the context of a production API to the context for mock execution. Thus, the modified executable 132 may perform production API behavior that takes action against the shadow database 142 (e.g., configuration changes) instead of the live database 140.

Another example mock API mode may perform user dictated API behavior. In this mode, a user may be prompted to specify the replacement behavior when the production API is replaced via functionality 114. In a particular example, dictated behavior may include returning a designated value (e.g., a fixed number such as zero, a pre-defined Boolean value such as false, a random number, a predefined sequence of numbers, etc.).

Another example mock API mode may perform production API behavior unless a condition is met and perform an override behavior when that condition is met. In some implementations, the override behavior may be specified by a user.

Another example mock API mode may be a partial replacement mode, where some production API behavior is performed and other production API behavior is replaced with mocked behavior. In an illustration, an original executable 130 may use a production API to check CPU usage of the network device 100, and if the CPU usage exceeds a certain threshold, the executable 130 may use a production API to turn off a feature (such as Open Shortest Path First protocol, OSPF). Under the partial replacement mode, the modified executable 132 may continue to use the production API behavior to check CPU usage, and may override the production API that turns off the feature after CPU usage exceeds the threshold. The override may include taking no action or performing one of the other modes described herein (e.g., logging mode, user dictated behavior mode, etc.).

The network device 100 may perform functionality 116 to execute the modified executable 132 on the network device 100. In some implementations, functionality 116 may include creating the shadow database 142, in the manner described above. By virtue of having replaced calls to production APIs with calls to mock APIs and using a shadow database, execution of the modified executable 132 may proceed without affecting operation of the network device 100, which may be running in a live deployment environment.

In some instances, executing a modified executable by functionality 116 may refer instead to altering the execution environment around the original executable 130, which may be useful if an original executable 130 cannot be changed or edited (e.g., the executable 130 is encrypted). Thus, in that sense, the modified executable 132 may be deemed to be the original executable 130 executing in an altered or artificial environment. For example, rather than modifying the original executable 130 by replacing API calls as described above, functionality 114 may identify the original executable 130 based on an associated calling context (e.g., process space) and mock certain behaviors of the original executable 130 based upon that context. To illustrate, if a pre-compiled executable 130 runs in a process space, the network device 100 may redirect write requests from that process space to the shadow database 142, while not redirecting requests from other process spaces.

The network device 100 may perform functionality 118 to record information associated with execution of the modified executable 132 on the network device 100. The information may be useful for post-execution analysis. Functionality 118 may record the information during execution or may collect information recorded by other means, such as the mock API logging mode described above. In some implementations, the recorded information may relate to calls to the mock APIs and/or calls to any unmodified production APIs. For example, recorded information may include, without limitation, a count of calls to each of the mock APIs, a count of calls per Uniform Resource Identifier (URI), network device 100 resource utilization (e.g., CPU usage, memory usage, etc.) associated with each of the mock APIs, changes made to the shadow database 142 by the mock APIs, or other information about mock API calls. The foregoing examples may be non-exclusive, in that multiple types of information may be recorded for the same execution. In some implementations, functionality 118 may also save a copy of the shadow database 142 in the recorded information, thus preserving any modifications made to the shadow database 142 by the mock APIs.

While observing the modified executable 132 on a test network from an external network entity may reveal what the executable does in terms of observable outputs, recording information about the execution of the modified executable 132 on the network device 100 itself in the foregoing manner provides richer and deeper insight into how the modified executable 132 performed and how the original executable 130 may be expected to perform. For example, statistics about a count of calls may be analyzed to determine a number of read and/or write requests, from which an impact on network device 100 I/O capacity may be inferred.

In some implementations, the network device 100 may perform functionality 120 that includes one or more post-execution actions. In an example, a post-execution action performed by the network device 100 may include generating statistics (e.g., descriptive statistics) about performance of the mock APIs, based on the information recorded via functionality 118. The statistics for the test execution may be provided in a report to user. By virtue of providing a user with information captured during execution of the modified executable 132 on the network device 100, as opposed to observing the modified executable from an external entity for example, the user may be provided with richer and deeper insight about how the original executable 130 may be expected to perform.

In another example, a post-execution action performed by the network device 100 may include extrapolating, from the information recorded via functionality 118, what configuration changes would be made to the network device 100 by execution of the original executable 130. For example, the network device 100 may analyze the shadow database 142 or other recorded information to identify the configuration changes made by mock APIs.

In another example, a post-execution action performed by the network device 100 may include sending the information 160 associated with execution of the modified executable 132 (as recorded via functionality 118) to an executable management system 150. In some implementations, the executable management system 150 may be a central data center or the like. In particular, the executable management system 150 may be related to a service provided the vendor of the network device 100 or a third-party associated with the network device 100.

In some implementations, the executable management system 150 may maintain a repository 152 of executables. For example, the repository 152 may be part of a marketplace of executables that owners of network devices 100 can publish to or download from. In some cases, some executables in the repository 152 may share similarities with each other and with the original executable 130, such as similarities in using the same or similar APIs. The executable management system 150 may also have access to performance data and execution information for executables in the repository 152. Thus, the executable management system 150 can analyze the information 160 from execution of modified executable 132 (serving as a proxy for performance of original executable 130) relative to performance data of other similar executables in a repository 152 to detect anomalies in the information 160. For example, the executable management system 150 may utilize machine learning techniques to model normal behavior across a group of similar executables in the repository 152, and information 160 may be compared against the model to detect anomalies. Anomalies may relate to abnormal API calls, abnormal resource usage, or other behavior that deviates from the modeled normal behavior.

In an illustration, the executable management system 150 may determine based on repository executables that normal behavior for executables that monitor port speeds should not exhibit any write calls to routing configuration. If information 160 indicates that execution of the modified executable 132 made mock write API calls to routing configuration, the executable management system 150 may flag such behavior as anomalous.

The executable management system 150 may also calculate a score based on how far the performance of modified executable 132, as represented by information 160, deviates from the model of normal behavior based on executables of the repository 152. The score may be deemed a trustworthiness score, as it may be useful for indicating to a user whether the original executable 130 (represented by performance of the modified executable 132) is close to normal and thus trustworthy, or if the executable 130 may exhibit some degree of abnormality or anomalous behavior and is thus less trustworthy.

In some implementations, the executable management system 150 may generate a performance report 162 to summarize the analysis of the information 160, and the network device 100 may receive the performance report 162 from the executable management system 150. The report may summarize any detection of anomalies. The report may also include the aforementioned trustworthiness score.

In some implementations, the network device 100 may control execution of the original executable 130 based on the performance report 162 received from the executable management system 150. For example, if the performance report 162 indicates no anomalies or indicates a trustworthiness score better than a certain threshold (e.g., a user defined or default threshold), then the network device 100 may permit full execution of the original executable 130 without limitation. On the other hand, if the performance report 162 indicates one or more anomalies or a trustworthiness score worse than the certain threshold, the network device 100 may either prohibit execution of the original executable 130 altogether or may limit execution of the original executable 130 (e.g., by prohibiting the anomalous calls or behaviors identified in the report 162; by reducing resources, permissions, or capacity available to the original executable; etc.). In some implementations, the threshold and the extent of the limitations placed on execution may be configurable.

FIG. 2 depicts an example system 200 that includes a non-transitory, machine readable medium 204 encoded with example instructions 206, 208, 210, 212 (collectively, instructions 206-212) executable by a processing resource 202. In some implementations, the system 200 may serve as or form part of the network device 100. For example, the instructions 206-212 may be included in instructions 106 and may be useful for implementing at least some of functionality 112-120.

The processing resource 202 may include a microcontroller, a microprocessor, central processing unit core(s), an ASIC, an FPGA, and/or other hardware device suitable for retrieval and/or execution of instructions from the machine readable medium 204 to perform functions related to various examples. Additionally or alternatively, the processing resource 202 may include or be coupled to electronic circuitry or dedicated logic for performing some or all of the functionality of the instructions described herein.

The machine readable medium 204 may be any medium suitable for storing executable instructions, such as RAM, ROM, EEPROM, flash memory, a hard disk drive, an optical disc, or the like. In some example implementations, the machine readable medium 204 may be a tangible, non-transitory medium. The machine readable medium 204 may be disposed within the system 200, in which case the executable instructions may be deemed installed or embedded on the system 200. Alternatively, the machine readable medium 204 may be a portable (e.g., external) storage medium, and may be part of an installation package. As described further herein below, the machine readable medium 204 may be encoded with a set of executable instructions 206-212. It should be understood that part or all of the executable instructions and/or electronic circuits included within one box may, in alternate implementations, be included in a different box shown in the figures or in a different box not shown. Some implementations of may include more or fewer instructions than are shown in FIG. 2.

Instructions 206, when executed, cause the processing resource 202 to receive an original executable for testing. The original executable may be received at the system 200, which may be a network device like network device 100. Instructions 206 may relate to functionality 112.

Instructions 208, when executed, cause the processing resource 202 to generate a modified executable by replacing calls in the original executable to production APIs with calls to mock APIs. For example, a mock API may include one or more of various modes, such as a read-only mode, a mode to read from and/or write to a shadow database instead of a live database that supports operation of the system 200, a mode that performs user dictated API behavior, a mode that performs production API behavior unless a condition is met and that performs an override behavior upon the condition being met, a mode to perform some production API behavior and some mocked behavior (e.g., user dictated behavior), or any other mode described herein. Instructions 208 may relate to functionality 114.

Instructions 210, when executed, cause the processing resource 202 to execute the modified executable generated by instructions 208 on the system 200 using a shadow database instead of a live database. Instructions 210 may relate to functionality 116.

Instructions 212, when executed, cause the processing resource 202 to record information associated with execution of the modified executable on the system 200. The recorded information may be used for post-execution analysis. Instructions 212 may relate to functionality 118. For example, the information may include a count of calls to the mock APIs made during the execution of the modified executable and/or information about network device resource utilization (e.g., CPU, memory, etc.) associated with mock API calls during execution of the modified executable.

FIG. 3 depicts an example system 300 that includes a processing resource 302 coupled to a non-transitory, machine readable medium 304 encoded with example instructions. System 300 may serve as or form part of a network device, like network device 100. The processing resource 302 and the machine readable medium 304 may be analogous in many respects to the processing resource 202 and the machine readable medium 204, respectively.

The machine readable medium 304 may be encoded with a set of executable instructions 306, 308, 310, 312, 314, 316 (collectively, instructions 306-316). It should be understood that part or all of the executable instructions and/or electronic circuits included within one box may, in alternate implementations, be included in a different box shown in the figures or in a different box not shown. Some implementations of may include more or fewer instructions than are shown in FIG. 3. In some implementations, one or more of the instructions 306-316 may operate in conjunction or in combination with one or more of the instructions 206-212 described above. In some implementations, one or more of the instructions 306-316 may be included in instructions 106 and may be useful for implementing some of functionality 112-120. In some implementations, one or more of instructions 308-316 may be executed by the processing resource 302 as part of post-execution actions (e.g., after execution of a modified executable via instructions 210).

Instructions 306, when executed, cause the processing resource 302 to create and maintain a shadow database. In some implementations, the shadow database may be synchronized one-way from the live database. For example, writes to the live database may be replicated to the shadow database, but writes to the shadow database are not replicated to the live database.

Instructions 308, when executed, cause the processing resource 302 to extrapolate what configuration changes would be made to the system 300 by execution of the original executable, from information recorded during execution of a modified executable (e.g., information recorded by instructions 212). For example, instructions 308 may analyze a history of mock API calls in the recorded information and determine what database configuration changes those calls are correlated to. In some implementations, instructions 308 may include analyzing the shadow database 142 to identify changes made by execution of the modified executable.

Instructions 310, when executed, cause the processing resource 302 to generate statistics about performance of the mock APIs from the recorded information. Statistics may include descriptive statistics like averages, histograms, counts, etc., and may relate to resource usage by the modified executable, the nature of mock API calls by the modified executable, etc.

Instructions 312, when executed, cause the processing resource 302 to send recorded information to an executable management system. The executable management system analyzes the information relative to other executables in a repository that are similar to the original executable to detect anomalies in the information. In some implementations, the executable management system may generate a score (i.e., a trustworthiness score) based on a quantity and/or severity of anomalies detected, for example.

Instructions 314, when executed, cause the processing resource 302 to receive a performance report from the executable management system. The report may be generated by the executable management system based on the detection of anomalies. Moreover, the report may also include the score generated by the executable management system.

Instructions 316, when executed, cause the processing resource 302 to control or limit execution of the original executable on the network device based on the performance report not meeting a threshold. For example, if the score does not meet a threshold, instructions 316 may disable parts or the whole of the original executable.

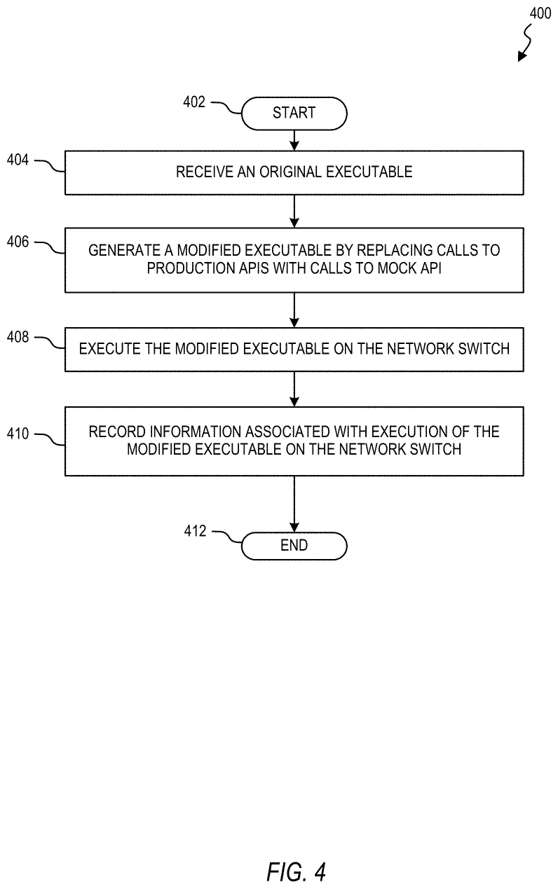

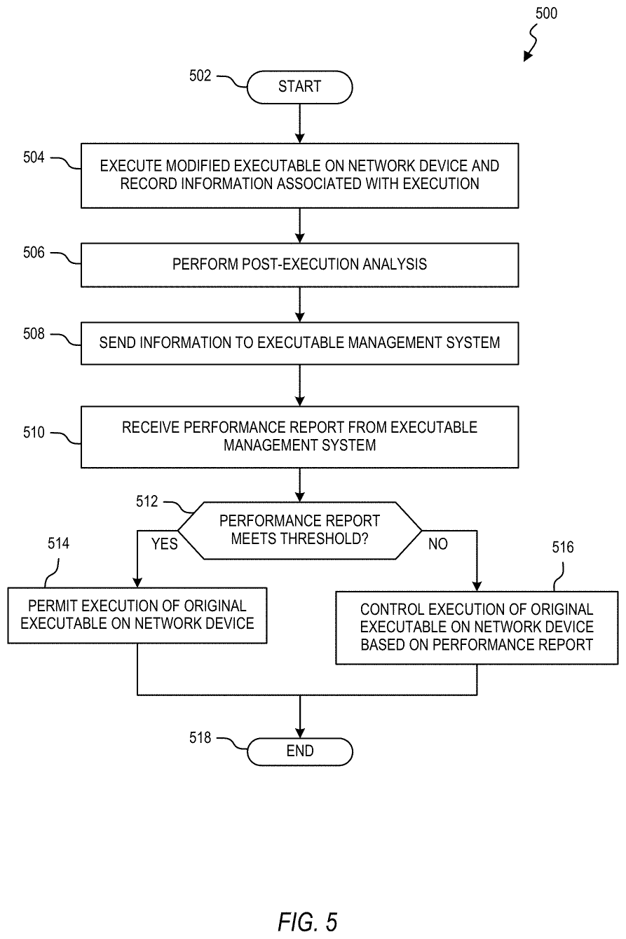

FIGS. 4 and 5 are flow diagrams depicting various example methods. In some implementations, one or more blocks of the methods may be executed substantially concurrently or in a different order than shown. In some implementations, a method may include more or fewer blocks than are shown. In some implementations, one or more of the blocks of a method may, at certain times, be ongoing and/or may repeat. In some implementations, blocks of the methods may be combined.

The methods shown in FIGS. 4 and 5 may be implemented in the form of executable instructions stored on a machine readable medium (e.g., such as machine readable medium 104, 204, or 304) and executed by a processing resource (e.g., such as processing resource 102, 202, or 302) and/or in the form of electronic circuitry. For example, aspects of the methods may be described below as being performed by a network device, which may be similar to network device 100.

FIG. 4 is a flow diagram depicting an example method 400. Method 400 starts at block 402 and continues to block 404, where a network device receives an original executable for testing.

At block 406, the network device generates a modified executable by replacing calls in the original executable to production APIs with calls to mock APIs. For example, a mock API may include a mode to read from and/or write to a shadow database instead of a live database, a mode that performs production API behavior unless a condition is met and that performs an override behavior upon the condition being met, a mode that performs user dictated API behavior, or any other modes described herein.

At block 408, the network device executes the modified executable using a shadow database that is synchronized one-way from a live database that supports operation of the network device. At block 410, the network device records information associated with execution of the modified executable on the network device for post-execution analysis. For example, the information may include a count of calls made to the mock APIs during the execution of the modified executable and/or metrics about network device resource utilization associated with mock API calls during execution of the modified executable. Method 400 ends at block 412.

FIG. 5 is a flow diagram depicting an example method 500. Method 500 starts at block 502 and continues to block 504, where the network device executes the modified executable (in a manner similar to block 408) and records information associated with that execution (in a manner similar to block 410).

At block 506, the network device may perform a post-execution analysis. Block 506 may include extrapolating what configuration changes would be made to the network device by execution of the original executable, based on the information recorded at block 504. Block 506 may include generating statistics about the performance of the mock APIs from the information recorded at block 504.

At block 508, the network device may send the information associated with execution of the modified executable to an executable management system. The executable management system may analyze the information relative to other executables in a repository that are similar to the original executable to detect anomalies in the information. The executable management system may also calculate a score based on the analysis against similar repository executables.

At block 510, the network device may receive a performance report about the analysis by the executable management system. For example, the report may include information about detected anomalies and/or the score.

The network device may control execution of the original executable on the network device based on the performance report received at block 510. The network device may check whether the performance report meets a threshold at block 512. For example, in some implementations, a performance report meets a threshold if the report includes no more than certain number of allowable anomalies (e.g., zero anomalies) or if a score included in the report meets a certain threshold. The threshold may be configurable in some implementations.

If the performance report meets the threshold (“YES” at block 512), the network device permits execution of the original executable on the network device at block 514. If the performance report does not meet the threshold (“NO” at block 512), the network device may control execution of the original executable on the network device. For example, the original executable may be prevented from executing on the network device altogether. In other examples, the network device may disable a part of the original executable, such as any offending API calls related to a reported anomaly. Thus, control of execution may be responsive to the severity of the performance report. Method 500 ends at block 518.

By virtue of the foregoing including the generation of a modified executable, performance and safety of scripts and pre-compiled applications may be verified on a deployed system, such as a network device or a switch, without affecting the deployed system. Data collection about the performance and API call behavior of the modified executable executing on the deployed system may provide a rich view of how the modified executable performed, and by extension, how the original, unmodified executable is likely to perform.

In the foregoing description, numerous details are set forth to provide an understanding of the subject matter disclosed herein. However, implementation may be practiced without some or all of these details. Other implementations may include modifications, combinations, and variations from the details discussed above. It is intended that the following claims cover such modifications and variations.

What is claimed:

1. A system comprising:
a processing resource in a network device; and
a machine readable medium in the network device, storing instructions that, when executed, cause the processing resource to:
receive an original executable to be tested,
generate a modified executable by replacing calls in the original executable to production application programming interfaces (APIs) with calls to mock APIs,
execute the modified executable on the network device, and
record information associated with execution of the modified executable on the network device for post-execution analysis.

2. The system of claim 1, wherein
operation of the network device is based on a live database,
the machine readable medium stores instructions that cause the processing resource to create a shadow database that is a copy of the live database, and
the mock APIs include a mode to read from or write to the shadow database instead of the live database.

3. The system of claim 1, wherein the mock APIs include a mode to perform production API behavior unless a condition is met and perform an override behavior upon the condition being met.

4. The system of claim 1, wherein the mock APIs include a mode to perform user dictated API behavior.

5. The system of claim 1, wherein the information includes a count of calls to the mock APIs and network device resource utilization associated with the mock APIs.

6. The system of claim 1, wherein the machine readable medium stores instructions to perform the post-execution analysis on the information by:
extrapolating from the information what configuration changes would be made to the network device by execution of the original executable, and
generating statistics about performance of the mock APIs.

7. The system of claim 1, wherein the machine readable medium stores instructions to send the information associated with execution of the modified executable to an executable management system, and
the executable management system analyzes the information relative to other executables in a repository that are similar to the original executable to detect anomalies in the information.

8. The system of claim 7, wherein the machine readable medium stores instructions to receive a performance report from the executable management system that is generated by the executable management system based on detection of anomalies.

9. The system of claim 8, wherein the machine readable medium stores instructions to control execution of the original executable based on the performance report received from the executable management system.

10. A method comprising:
receiving, by a network device, an original executable for testing;
generating, by the network device, a modified executable by replacing calls in the original executable to production application programming interfaces (API) with calls to mock APIs;
executing, by the network device, the modified executable using a shadow database that is synchronized one-way from a live database that supports operation of the network device; and
recording, by the network device, information associated with execution of the modified executable on the network device for post-execution analysis.

11. The method of claim 10, wherein the mock APIs include:
a mode to read from or write to the shadow database instead of the live database,
a mode that performs production API behavior unless a condition is met and that performs an override behavior upon the condition being met, or
a mode that performs user dictated API behavior.

12. The method of claim 10, wherein the information includes a count of calls to the mock APIs made during the execution of the modified executable and network device resource utilization associated with mock API calls during execution of the modified executable, and
the network device performs the post-execution analysis by:
extrapolating from the information what configuration changes would be made to the network device by execution of the original executable, and
generating statistics about performance of the mock APIs.

13. The method of claim 10, further comprising sending the information associated with execution of the modified executable to an executable management system,
wherein the executable management system analyzes the information relative to other executables in a repository that are similar to the original executable to detect anomalies in the information.

14. The method of claim 13, further comprising:
receiving, by the network device, a performance report from the executable management system that is generated by the executable management system based on detection of anomalies; and
controlling, by the network device, execution of the original executable on the network device based on the performance report.

15. A non-transitory machine readable medium storing instructions executable by a processing resource of a network device, the non-transitory machine readable medium comprising:
instructions to receive an original executable at the network device for testing;
instructions to generate a modified executable by replacing calls in the original executable to production application programming interfaces (API) with calls to mock APIs;
instructions to execute the modified executable on the network device using a shadow database that is synchronized one-way from a live database that supports operation of the network device; and
instructions to record information associated with execution of the modified executable on the network device for post-execution analysis.

16. The non-transitory machine readable medium of claim 15, wherein the mock APIs include a mode to read from or write to the shadow database instead of the live database.

17. The non-transitory machine readable medium of claim 15, wherein the mock APIs include:
a mode that performs production API behavior unless a condition is met and that performs an override behavior upon the condition being met, or
a mode that performs user dictated API behavior.

18. The non-transitory machine readable medium of claim 15, wherein the information includes a count of calls to the mock APIs made during the execution of the modified executable and includes network device resource utilization associated with mock API calls during execution of the modified executable, and
the non-transitory machine readable medium further comprises instructions to perform the post-execution analysis, including:
instructions to extrapolate, from the information, what configuration changes would be made to the network device by execution of the original executable, and
instructions to generate statistics about performance of the mock APIs.

19. The non-transitory machine readable medium of claim 15, further comprising:
instructions to send the information associated with execution of the modified executable to an executable management system, wherein the executable management system analyzes the information relative to other executables in a repository that are similar to the original executable to detect anomalies in the information; and
instructions to receive at the network device a performance report from the executable management system that is generated by the executable management system based on detection of anomalies.

20. The non-transitory machine readable medium of claim 19, further comprising instructions to limit execution of the original executable on the network device based on the performance report not meeting a threshold.
